(19) United States
(12) Patent Application Publication
(10) Pub. No.: US 2006/0070022 A1
(43) Pub. Date: Mar. 30, 2006

(54) URL mapping with shadow page support

(75) Inventors: Walfrey Ng, North York (CA); Madeline Fok, Toronto (CA); Barbara Chow Yee Wong, North York (CA); Darl Andrew Crick, Keswick (CA); Yong Yuan, Scarborough (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/953,141

(22) Filed: Sep. 29, 2004

(51) Int. Cl. G06F 9/44

(52) U.S. Cl. 717/104; 717/120

(57) ABSTRACT

A technique for managing a web page having at least one URL supporting search engine preferred Universal Resource Locator (URL) links through URL mapping and shadow page support is provided. Because a search engine crawler typically does not want to crawl through dynamic URLs, a search engine friendly page would typically contain static URLs. Support is provided for obtaining the web page containing the at least one URL link and determining the at least one URL link to be of a dynamic format then converting the dynamic format of the at least one URL link into a static format. Next, a shadow page of the web page is created, containing the static format link, and placed in the shadow page repository. A web application server may then enabled to provide a URL mapping function to convert such a static URL to a desired dynamic format, based on a provided mapping file. Web administrators or developers may then define an entry in such a mapping file for each URL key that needs to be mapped.

### BACKGROUND OF THE INVENTION

1. Field of the Invention

The present invention relates generally to preparing web site pages for indexing by search engines and more specifically to supporting search engine preferred Universal Resource Locator (URL) links through URL mapping and shadow page support.

2. Description of the Related Art

Many people rely on search engines to locate requested information from the World Wide Web. It is therefore very important for companies providing product information on websites to have their website pages indexed by the search engines for prompt retrieval. For example, within the current electronic business community, it may be considered a lost sales opportunity when people requesting product information from a website cannot find that product information using a search engine.

Universal Resource Identifiers (URI) provides the addressing technology required to identify resources on the Internet as well as private intranet networks. Universal Resource Locators are addresses with network locations and are a type of URI. The Hyper Text Transfer Protocol (HTTP) URI (a URL) is an address typed into a browser or embedded in a web page as a hyperlink.

URLs may take different forms depending upon their intended use and audience therefore URLs used on the client side may often differ in form from those used on the server side. The client side may have a preference for an easy to use or remember URL while the URLs of the server side may be designed for programmatic control and specificity. Function often dictates a difference in form. Electronic business websites usually contain pages that are dynamic in nature and database-driven. These dynamic pages typically include “stop characters” (“?,” “&,” “%,” etc.) in their associated URLs. However, not all search engines will crawl through sites having these dynamic page URLs because the web crawlers can easily overwhelm the crawled sites with the generated dynamic content. Some search engines that will crawl through pages containing dynamic page URLs, limit the amount of dynamic URLs they index. In order to make these dynamic pages more crawlable by the search engine crawlers, static URLs without stop characters may have to be used.

Differing existing approaches have been used to solve this problem, but each has drawbacks. In some instances fixed software code was provided with built-in logic or mapping to handle the desired format changes. However any changes in either input or output format required corresponding changes in the code in support of the changes. Maintenance times then became a factor leading to longer turnaround time for the mappings to be available.

In other cases some web servers provided a rules-based rewriting system to rewrite the URL. The URL rewrite allowed conversion from a static URL back to the dynamic URL used by the web application. However, a URL rewrite system was typically difficult to program and debug. Also, since the URL format had to be changed, the URL format in associated JSP pages also needed changing accordingly. Providing reverse mappings through rules based implementations typically increased the overall level of difficulty and reduced the ability to provide a hierarchical organization to the rules because the rules were embedded into the code.

Another approach used created static copies (shadow pages) of the dynamically-generated pages for the crawlers to index. In these cases, the crawlers would be able to crawl through the resulting static copies of the pages. However, these static copies were typically very hard to maintain because as the product and other catalog information changed frequently, the corresponding static page copies needed to be manually updated to remain synchronized with the associated dynamic page content.

It would therefore be highly desirable to have a more effective means for web site indexing of web pages while providing dynamic page information.

### SUMMARY OF THE INVENTION

Conveniently, software exemplary of an embodiment of the present invention allows a solution comprising a URL mapping function used in conjunction with a dynamic shadow site map page capability thereby addressing web site page indexing efficiency.

Because a search engine crawler typically does not want to crawl through dynamic URLs, a search engine friendly page would typically contain static URLs. A web application server may then provide a URL mapping function to convert such a static URL to a desired dynamic format, based on a provided mapping file. Web administrators or developers may then define an entry in such a mapping file for each URL key that needs to be mapped.

Based on information in a mapping file, the mapping function would convert a static format URL for example http://hostname/webapp/wcs/stores/servlet/product_{—}10001_{—}10001_{—}10032_{—}−1) preferred by a web crawler to a corresponding dynamic format URL, for example http://hostname/webapp/wcs/stores/servlet/ProductDisplay?storeId=10001&catalogId=10001&productId=10032&langId=−1 that a web application understands.

Web pages that are designed for human visitors are usually not “friendly” pages for web crawlers. These pages may discourage web crawlers due to excessive graphics or extremely large page size. This issue may be addressed through provision of an appropriate site map comprising pages optimized for web crawlers. A general approach may be to provide a static site map that contains web crawler friendly pages with static format URLs. However, if product and other catalog information changes frequently, then the corresponding static copies of the web pages will need to be updated frequently, making this approach of page management very hard to maintain.

To avoid such maintenance issues related to fixed or static page offerings, Java Server Pages (JSPs) may be used to construct shadow pages dynamically thereby having dynamic content. A difference between the shadow site map pages created using this technique compared with the regular pages is that the URLs of the shadow site map pages will not contain the “stop characters” as found in the regular pages. For example, if the regular page URL is, “http://hostname/webapp/wcs/stores/servlet/ProductDisplay?storeId=10001&catalogId=10001&productId=10032&langId=−1”, then the corresponding shadow page URL would be “http://hostname/webapp/wcs/stores/servlet/product_{—}10001_{—}10001_{—}10032_{—}−1”. The web application would then be required to translate the static looking URL back to a dynamic URL using the mapping file and locate the resulting JSP in the site map subdirectory specified in the mapping file.

Furthermore, to reduce the time in developing shadow site map JSP pages (containing static links), a tool may be provided to change the URL format in the JSP pages automatically when the URL format is changed. The tool reads the mapping file, converting the dynamic URLs in the JSP pages to a static format URL. Such a tool may typically take the form of programmatic scripts which may be implemented in a programming language for example the Perl language.

A web developer may then copy a JSP for the regular web page into a copied page or intermediate page, convert the JSP to use static URL format through use of the tool, and then further optimize the site map pages created to be more search engine friendly. Further optimization may take the known form of stripping out unnecessary graphics and interpretive code of the intermediate page. Optimization may take the form of programmatic means for example those accomplished by scripts or manual editing of the intermediate page. The process result is two sets of pages; the regular pages as at the start of the process and the optimized shadow map pages. Both sets are available concurrently. The shadow site map pages may also be human visitor friendly helping site visitors to navigate through the entire site.

Embodiments of the present invention typically address drawbacks of the existing URL rewrite approach. While the existing URL rewrite approach is typically difficult to program and debug, embodiments of the present invention typically do not require programming. Using an implementation of an embodiment of the instant invention, web administrators need only update a mapping file. Furthermore, while the existing URL rewrite approach does not consider the JSP modifications required due to URL format changes, an embodiment of the present invention typically employs a tool in the form of scripts to convert the URL format in the JSP pages based on a provided mapping file. The same mapping file may then be used by the URL mapping module to reverse map the static URL back to the dynamic URL desired by the web application. Embodiments of the present invention may then use JSPs, as constructed shadow site map pages, retaining their dynamic properties which will automatically contain product information updates from a changing product database.

In one embodiment there is provided a data processing system-implemented method for managing a web page having at least one URL link, the data processing system-implemented method comprising; obtaining the web page containing the at least one URL link; determining the at least one URL link to be of a dynamic format; converting the dynamic format of the at least one URL link into a static format; creating a shadow page, of the web page, containing the static format link; and placing the shadow page in a repository.

In another embodiment there is provided a data processing system for managing a web page having at least one URL link, the data processing system comprising; an obtainer module for obtaining the web page containing the at least one URL link; a determination module for determining the at least one URL link to be of a dynamic format; a converter for converting the dynamic format of the at least one URL link into a static format; a generator for creating a shadow page, of the web page, containing the static format link; and an update module for placing the shadow page in a repository.

In yet another embodiment there is provided an article of manufacture for directing a data processing system for managing a web page having at least one URL link, the article of manufacture comprising; a program usable medium embodying one or more instructions executable by the data processing system, the one or more instructions comprising; data processing executable instructions for obtaining the web page containing the at least one URL link; data processing executable instructions for determining the at least one URL link to be of a dynamic format; data processing executable instructions for converting the dynamic format of the at least one URL link into a static format; data processing executable instructions for creating a shadow page, of the web page, containing the static format link; and data processing executable instructions for placing the shadow page in a repository.

Other aspects and features of the present invention will be set forth in the description which follows and in part will become apparent to those of ordinary skill in the art upon review of the following description of specific embodiments of the invention in conjunction with the accompanying figures. Aspects of the present invention may be realized and attained by means of the elements and combinations particularly pointed out in the appended claims. It is to be understood that both the foregoing general description and the following detailed description are exemplary and explanatory only and are not restrictive of the invention as claimed.

As stated earlier URLs are a type of URI, therefore when a URL has been used in an explanation of an embodiment of the present invention it is understood that other types of URIs may be applicable as well.

### BRIEF DESCRIPTION OF THE DRAWINGS

The accompanying drawings, which are incorporated in and constitute part of this specification, illustrate embodiments of the present invention and together with the description serve to explain the principles of the present invention. Embodiments illustrated herein do not serve to limit the precise arrangement and instrumentalities shown, wherein:

FIG. 1 is a block diagram of a computer data processing system which may be used to incorporate an embodiment of the present invention;

FIG. 2 is a block diagram illustrating an embodiment of the present invention within the context of the environment of FIG. 1;

FIG. 3a is a block diagram illustrating in a high level view, URL mapping components in an embodiment of the present invention of FIG. 2;

FIG. 3b is a flow chart illustrating a process for URL mapping in an embodiment of the present invention of FIG. 3a;

FIG. 3c is a flow chart illustrating a process for site map creation in an embodiment of the present invention of FIG. 3a; and

FIG. 4a is a block diagram of the web page topology of a typical web site while FIG. 4b is a block diagram of the elements of FIG. 4a in a shadow site map in an embodiment of the present invention of FIG. 2;

FIG. 5 is a text based example showing the relationship between URL formats; and

FIG. 6 is a pictorial view of a URL in regular form in a regular site compared to a URL in static form in a shadow site map.

Like reference numerals refer to corresponding components and steps throughout the drawings.

### DESCRIPTION OF THE PREFERRED EMBODIMENT

Embodiments of the present invention provide a data processing system-implemented method, system and article of manufacture for facilitating web site indexing using URL mapping in conjunction with a dynamic shadow site map. In accordance with the present invention, the process of enhancing web site indexing may be bifurcated into a URL mapping process and a dynamic shadow site map creation process. In the URL mapping process, static URLs are mapped back to dynamic URLs as needed by the web application. In the shadow site map creation process, shadow pages are provided that have been optimized for use by web crawlers. In this way indexing of web site pages is enhanced for use by search engines.

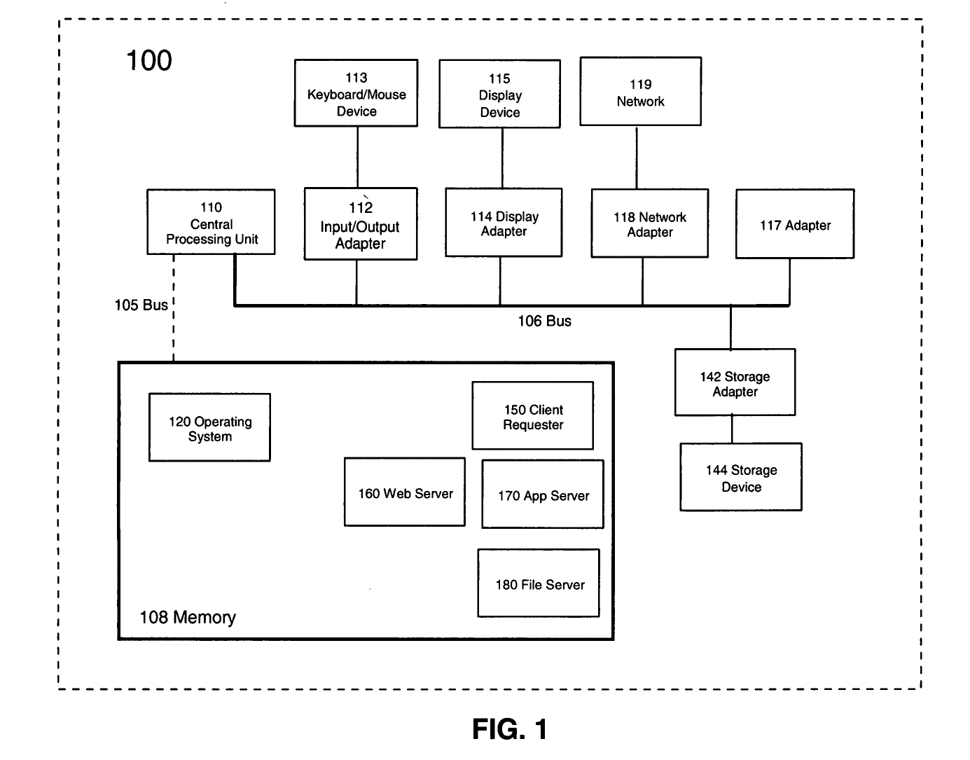

FIG. 1 depicts, in a simplified block diagram, a computer system 100 suitable for implementing embodiments of the present invention. Computer system 100 has a central processing unit (CPU) 110, which is a programmable processor for executing programmed instructions stored in memory 108. Memory 108 can also include hard disk, tape or other storage media. While a single CPU is depicted in FIG. 1, it is understood that other forms of computer systems can be used to implement the invention, including multiple CPUs. It is also appreciated that the present invention can be implemented in a distributed computing environment having a plurality of computers communicating via a suitable network 119, for example the Internet.

CPU 110 is connected to memory 108 either through a dedicated system bus 105 and/or a general system bus 106. Memory 108 can be a random access semiconductor memory for storing components of an embodiment of the present invention for example client requester 150, web server 160, application server 170 and file server 180 as will be described later. Memory 108 is depicted conceptually as a single monolithic entity but it is well known that memory 108 can be arranged in a hierarchy of caches and other memory devices. FIG. 1 illustrates that operating system 120, also may reside in memory 108.

Operating system 120 provides functions for example device interfaces, memory management, multiple task management, and the like as known in the art. CPU 110 can be suitably programmed to read, load, and execute instructions of operating system 120. Computer system 100 has the necessary subsystems and functional components to implement support for embodiments of the present invention for example data structures as will be discussed later. Other programs (not shown) include other server software applications in which network adapter 118 interacts with the other server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology that may be used to depict results provided by an implementation of an embodiment of the present invention. The Input/output adapter 112 supports devices suited for input and output, for example keyboard or mouse device 113, and a disk drive unit (not shown). Storage adapter 142 supports one or more data storage devices 144, which could include a magnetic hard disk drive or CD-ROM drive although other types of data storage devices can be used, including removable media for storing data files for example those managed or obtained through file server 180 in support of an implementation of an embodiment of the present invention. File server 180 is a general term used to cover both file and database type persistent data.

Adapter 117 is used for operationally connecting many types of peripheral computing devices to computer system 100 via bus 106, for example printers, bus adapters, and other computers using one or more protocols including Token Ring, LAN connections, as known in the art. Network adapter 118 provides a physical interface to a suitable network 119, for example the Internet. Network adapter 118 includes a modem that can be connected to a telephone line for accessing network 119. Computer system 100 can be connected to another network server via a local area network using an appropriate network protocol and the network server can in turn be connected to the Internet. FIG. 1 is intended as an exemplary representation of computer system 100 by which embodiments of the present invention can be implemented. It is understood that in other computer systems, many variations in system configuration are possible in addition to those mentioned here.

It is to be understood that the general system in support of an implementation of an embodiment of the present invention normally includes a set of utilities. These utilities comprising assorted software modules will not be described but are commonly found and used to provide a variety of services, for example, obtaining files, updating files, retrieving files, copying files, scripting service for development and execution of scripts for example but not limited to the Perl language. There are also services provided for comparison operations and parsing operations as required for general string manipulation. Passing or transferring of information between programs is also known support within such a system. Further general web support services for receiving and sending responses is provided. Where described in detail later optimization may be performed within an optimizer which may consist of software routines as implemented within a script or other programmatic means. Such means may also be further augmented by manual tuning of results. Comparisons as used in determination of presence or absence of characters within strings may also be another example of typical services provided by the general purpose system.

Client requester 150 typically provides a graphic user interface or other programmatic means to generate requests for URL based resources and to receive results of such requests. Client requester 150 may be a browser based client or web crawler. Such a client may or may not be on the same machine or system as other components listed next. Web server 160 typically contains applets to be used by the clients, servlets for execution on the server and other forms of programs and data cached for either client or application server use with typical communication between such entities via Hypertext Transmission Protocol (HTTP). App server 170 manages requests for application logic and database transactions with File server 180. File server 180 is responsible for storing, direct manipulation and management of data in persistent form for example that found in a typical relational or object oriented database. Physical data may reside on storage device 144 controlled by storage adapter 142.

Client requester 150 generates a request including a URL string that may be simple to use and user friendly for a resource located on or through file server 180. The request is received by web server 160 and passed to app server 170 for resolution. App server 170 passes the result obtained from file server 180 to client requester 150 to complete the transaction.

Although FIG. 1 shows all of these functions being performed within a single system, system 100, it is likely that the actual embodiments would employ several servers and systems functioning cooperatively to manage large numbers of users. The various functions just described may be distributed among several data processing systems as dictated by processing needs while communicating as required through a network 119 for example the Internet via network adapter 118. The functions may be logically separate while on a single physical system as shown or physically separate and dispersed among a plurality of interconnected systems without impact on the basic principles and service.

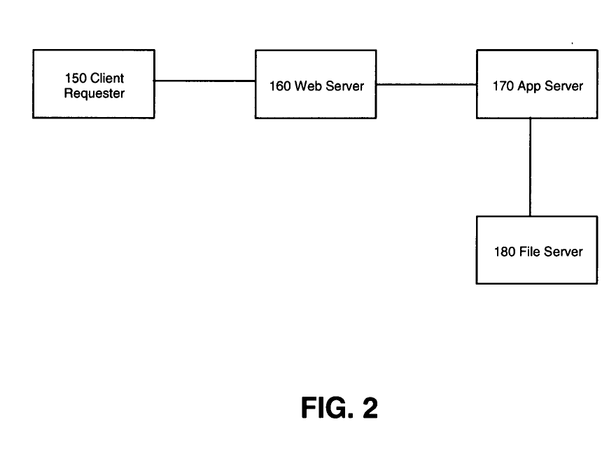

In a more particular illustration of an embodiment of the present invention, FIG. 2 is a block diagram illustrating the logical relationship of the high level components. It may be appreciated by those skilled in the art that a mapping function (which may have bundled services for example parsing, comparing, replacing) as required to perform mapping between a static and a dynamic form of URL is to be found within or accessible by app server 170. Again by direct or indirect reference a directory containing the shadow site map pages is available to the mapping function of app server 170 to resolve requests received from client requester 150 through web server 160. The mapping file typically contains the mapping entry for each type of URL desired to be transformed. The same mapping file may be used to map URLs in either direction. Typically the specific file location or directory of the shadow site map pages may be indicated in the individual mapping file. Alternatively a configuration file accessible by app server 170 may be used to indicate a file repository or directory that contains the desired shadow site map pages.

App server 170 will provide a URL mapping functionality that will convert static URL back to the dynamic format, based on a mapping file. Web administrators or developers can define an entry in the mapping file for each URL type that needs to be mapped.

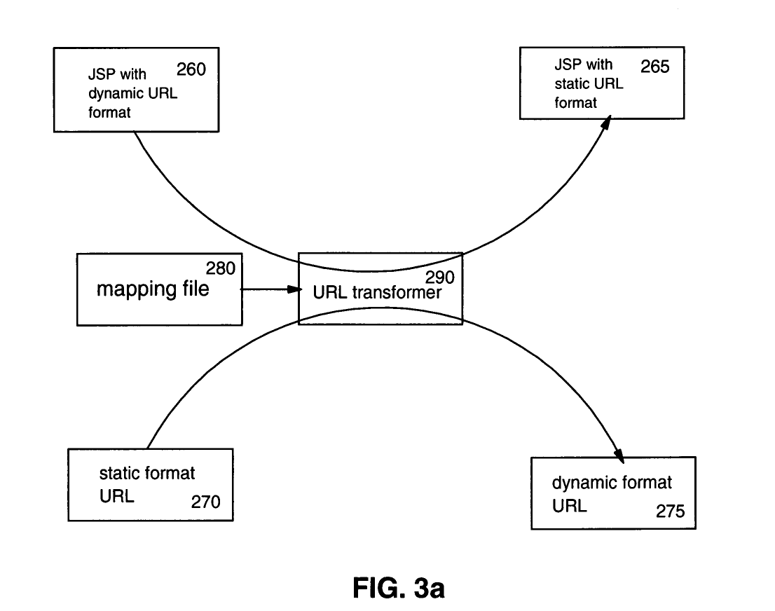

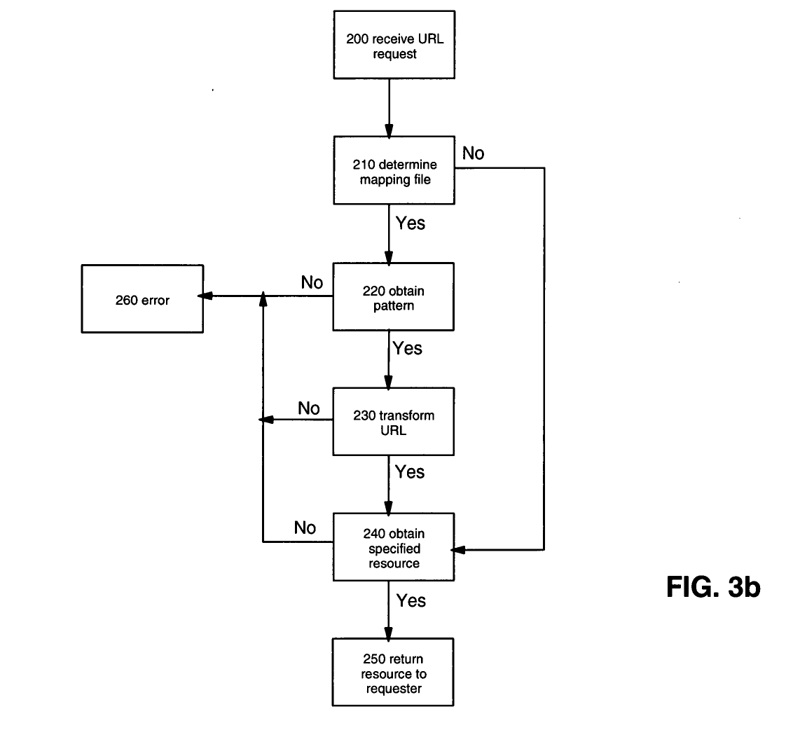

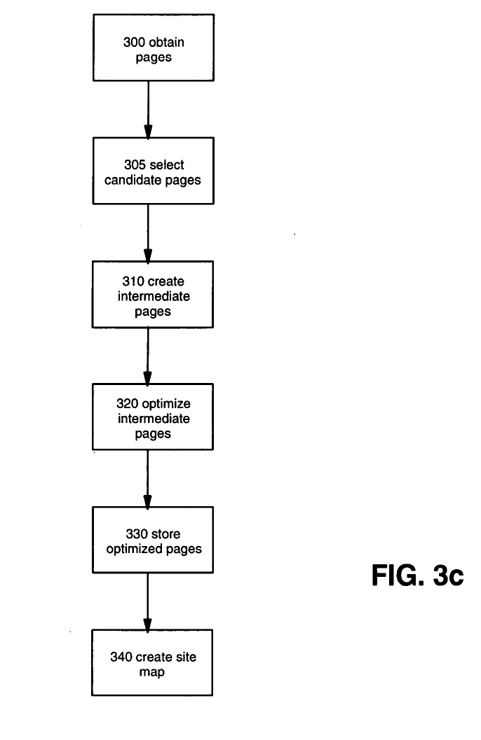

Referring now to FIG. 3A is a block diagram illustrating in a high level view, URL mapping components in an embodiment of the present invention of FIG. 2. JSP with dynamic format 260 represents an input JSP that contains dynamic format links. This input is processed through URL transformer 290 which uses mapping definitions obtained from mapping file 280 to process JSP with dynamic format 260 to create JSP with static format 265. While the format of the link is transformed into a static format the actual JSP derived content remains dynamic. A script may be generated through use of definitions in mapping file 280 to convert the links within JSP with dynamic format 260 from the dynamic format to static format of JSP with static format 265. Scripting for example in a converter is but one form of programmatic conversion known to those skilled in the art that may be employed to accomplish these same results.

Static format URL 270 may also be mapped through URL transformer 290 as in a mapping module using content of mapping file 280 to produce dynamic format URL 275. In doing so app server 170 can convert the static format URL back to a dynamic format URL to be used by the web application on app server 170. This mapping may also be reversed using mapping file 280.

URL transformer 290 may contain multiple modules for converting and mapping of URLs during the transforming process. Support for these services is also found with the underlying system in the form of the usual string manipulation services including comparator for pattern matching, substring, and substitution or replacement operations.

FIG. 3B is a flow diagram illustrating the URL mapping process of an embodiment of the present invention. The mapping process begins in operation 200 upon receipt of a request from client requester 150 through web server 160 by app server 170. During operation 210 a determination is made regarding whether a mapping is to be performed by determining if this is a static form of URL and if so which specific JSP file should be used to construct the result. A determination module containing simple pattern matching comparator techniques may be used to check the URL format. If no URL mapping is desired, the URL is already in dynamic URL format, processing would move to operation 240 otherwise proceed to operation 220. Having obtained a mapping file during operation 210, as indicated for example in a configuration file of app server 170, pattern matching information is obtained in operation 220. If no match can be found processing would move to 260 in which an error status would be raised. Otherwise processing would move to operation 230 during which the necessary transform would occur for the matched URL key. If the transform of operation 230 failed, processing would have moved to operation 260 and an error status raised as before. Otherwise processing would have moved to operation 240 in which the requested resource would have been obtained through file server 180. If the specified resource could not be obtained, processing would have moved to operation 250 and raised an error status as before. Having obtained the requested resource it would have been returned to client requester 150 during operation 250.

Given a sample portion of a mapping entry defined as follows:

<mappings>

<pathInfo_mappings separator=“_” subdirectory=“SiteMap”>
<pathInfo_mapping name=“category” requestName=“Category
Display”>

<parameter name=“storeId”/>
<parameter name=“catalogId”/>
<parameter name=“categoryId”/>
<parameter name=“langId”/>

</pathInfo_mapping>
. . .

</mappings>

then a static URL for example http://hostname/webapp/wcs/stores/servlet/category_{—}10001_{—}10251_{—}10231_{—}−1 would be converted to the following dynamic format URL http://hostname/webapp/wcs/stores/servlet/CategoryDisplay?storeId=10001&catalogId=10251&categoryId=10231&langId=−1 using the mapping process.

Based on information from the mapping file, the application code on app server 170 would parse the tokens and map them back to the appropriate name-value pairs. In one description of a mapping file embodiment the “pathInfo_mapping” element would contain the following attributes:

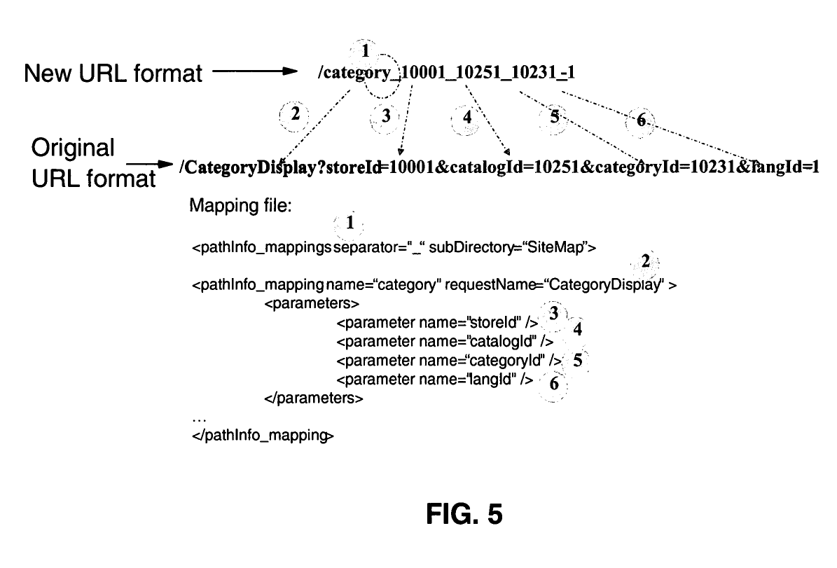

separator; used as the delimiter to separate the concatenated parameter values. For example, if the separator=“_”, then the URL mapping would appear as: webapp/wcs/stores/servlet/product_{—}10001_{—}10001_{—}10032_{—}−1. The separator may be seen in FIG. 5 as the pair of reference numeral 1.

subdirectory; used to specify the sub directory or directory where the shadow site map pages are located. This entry may also be seen in FIG. 5, but there is no mapping as the entry is just informative.

name, requestName; specifies a source-name, target-name pairing. From the web application point of view, the mapping function would determine if the incoming static looking URL contains the specified “name”, if so, map it to the corresponding “requestName” specified in the mapping file. For example, for the name=“product” and the requestName=“ProductDisplay”, the incoming name, “product” would be mapped to “ProductDisplay”. For example, webapp/wcs/stores/servlet/product_{—}10001_{—}10001_{—}10032_{—}−1 to webapp/wcs/stores/servlet/ProductDisplay?storeId=10001&catalogId=10001 &productId=10032&langId=−1. Again as shown in FIG. 5, using reference numeral 2, it may be seen that “category” maps to “Category Display”.

The “parameter” element contains the attribute “name” used to specify the name of the parameter that needs to be concatenated. This example is also shown in FIG. 5 using reference numerals 3, 4, 5, and 6. In the original format URL can be seen the name value pair of “storeId=10001”. This combination has been mapped to “10001” in the new URL format, having lost the identifier portion of “storeId”. Each of the parameter “name-value” pairs has been mapped to just the “value” portion in the new URL format.

Providing an appropriate site map that is optimized for a web crawler is very useful for search engine optimization. The site map should contain web crawler friendly shadow pages that use static looking URLs instead of dynamic URLs. In most cases, web pages are designed with human visitors in mind and are not designed for web crawlers. Therefore pages designed to read by people may discourage off web crawlers due to excessive graphics and extremely large page size.

The second portion of an embodiment of the instant invention provides a capability of a site map that has shadow pages containing static URLs typically preferred by web crawlers. To support different contents for the regular page as well as the shadow site map page, a web application provides the capability to use different JSP pages to construct the web contents for the same requested information. FIG. 3C is a flow diagram depicting a process used to create a shadow site map. Starting with operation 300, web pages that may be indexed are obtained. Next in operation 305 specific pages are selected as candidates for indexing. These copied pages are a subset of the web pages of operation 300 with the actual pages indexed determined by the web crawler. Typically low level (in a hierarchy of pages) pages are selected to provide more specific information and to reduce the size of the shadowed page repository. All pages traversed in path through the hierarchy are not necessarily required in the shadow page site map.

Next during operation 310 intermediate forms of the selected web pages are created. An intermediate form is created by processing the selected page through a tool, for example a script, to transform the input URL into a static format. During operation 320 the intermediate pages may then be further optimized by either manual or programmatic means. The optimization process typically removes unnecessary graphics from the input page as well as possibly stripping out unnecessary processing embedded within the page. An example of unnecessary processing may be the use of Java scripts contained within a page to construct the links. Typically simple text links are used instead.

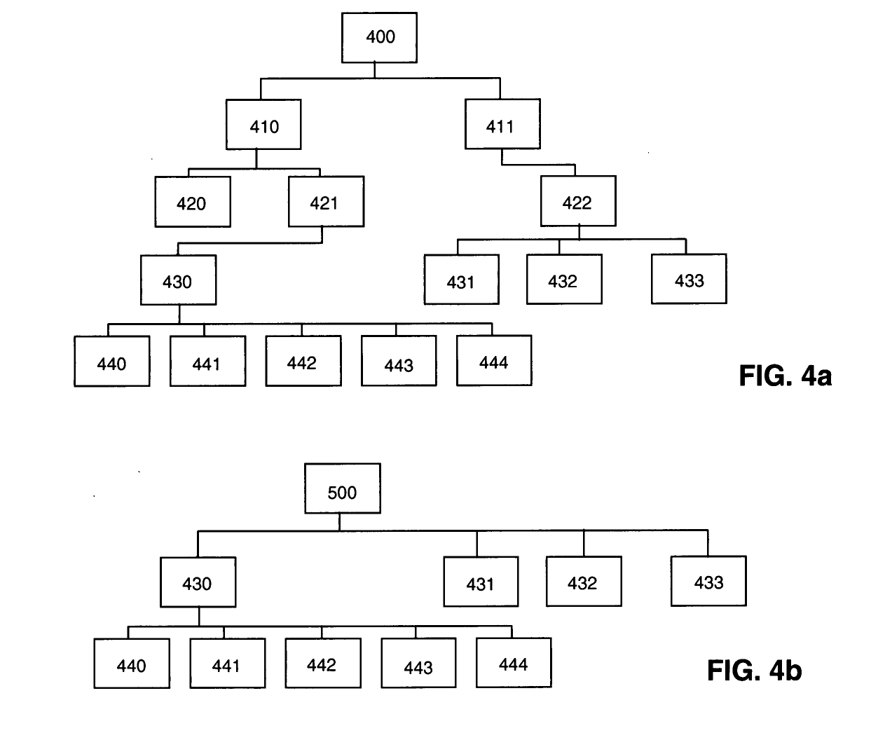

During operation 320 the optimized output is stored in a repository for example the one identified in the mapping file or configuration file of app server 160. Finally during operation 340 the site map of the shadow pages is created using known techniques. The shadow site map entry is a “root” page (see numeral 500 in FIG. 4b) containing the required links to the referenced pages in the directory of optimized shadow pages. It may be appreciated by those skilled in the art that creating a web page of links for example the shadow site map may include a hierarchy of links as required to support the shadow pages. Further the shadow site map pages are provided in addition to the regular page versions and hierarchy so that both versions are available concurrently. Each version is therefore suited to meet the requirements of its requesters. The regular page has not been replaced or made obsolete by the incorporation of the associated shadow page.

A web application now provides the capability to use different JSP pages to construct the web contents for the same information depending on whether the incoming request uses the static looking format, for example http://hostname/webapp/wcs/stores/servlet/product_{—}10001_{—}10001_{—}10032_{—}−1) or the original name-value pair dynamic format, as in http://hostname/webapp/wcs/stores/servlet/ProductDisplay?storeId=10001&catalogId=10001&productId=10032&langId=−1).

By specifying a subDirectory attribute in the mapping file (or otherwise logically associated with the mapping file), the web application would use a designated JSP page in the specified subdirectory as the shadow page. The following is an example of a mapping file indicating which file directory to use to obtain the shadow site map files:

<mappings>

<pathInfo_mappings separator=“_”subDirectory=“SiteMap”>
. . .

</mappings>

By specifying subDirectory=“SiteMap” in the mapping file, the web application will fetch a requested JSP file from the associated subdirectory “SiteMap” and not the regular page location. For example, if the original URL is associated with TopCategoriesDisplay.jsp, then the corresponding JSP associated with the shadow page will be SiteMap/TopCategoriesDisplay.jsp.

With this capability, instead of using the static copies of web pages as shadow pages for a web crawler, web site developers can develop another set of JSPs as the shadow pages. By using the described URL mapping capability, the JSPs for the shadow pages can use the static looking URLs while still providing dynamic content. Also, those JSPs can be written so that they may be optimized for the web crawler.

A further tool implemented in the form of scripting or other programmatic means may be used to change the URL format in JSP pages if the JSP is written using JavaServer Pages Standard Tag Library (JSTL). If JSP pages are written using JSTL, then the URL would be created through a <c:url> tag. By providing a specific implementation of the URL tag that reads the mapping file and converts the URL format accordingly, the JSP pages themselves do not need to be modified if a different URL format is defined in the mapping file.

<@ tag/lib uri=“http://commerce.ibm.com/base” prefix=“wcbase”%>
<wcbase:url var=“categoryDisplayUrl” value=“CategoryDisplay”>

<wcbase:param name=“catalogId”value=“${WCParam.catalogId)”/>
<wcbase:param name=“storeId” value=“${WCParam.storeId)”/>
<wcbase:param name=“categoryId” value=“${topCategoty.
categoryId)”/>

</wcbase:url>

In this case, even if the mapping file is changed to have another URL format, the JSP pages do not need to be changed again as the change may be accommodated through the transform of the mapping file.

A further tool such as scripting or other easy to use string manipulation means as is known in the art may also be used to change the URL format in the JSP pages if the JSP is written using Java code. If JSP pages are written using Java code, a script may then be provided that reads the mapping file, and converts the dynamic format URLs in the JSPs accordingly. For example, the script would convert the following URL:

CategoryDisplay?catalogId=<%=catalogId%>&categoryId=<%=category
DataBean.getCategoryId( )%>&storeId=<%=storeId%>

to a new URL format of:
Category_<%=catalogId%>_<%=storeId%>_<%=categoryDataBean.getCategoryId( )%>

This form of optimization using scripting for example would typically recursively process all the files in a specified directory (source directory), and then place the updated files into a designated result directory (containing either an intermediate or final form of the file). The original files would be left unchanged. Other script variations may be used similar to the technique just described to support additional program language variants as required.

Typically the script would also provide a warning in the situation where the mapping has fewer parameters than the URL request of the page. In such cases the mapping would be incorrect, therefore not performed and a warning would be generated to report this occurrence.

FIG. 4a is a block diagram illustrating a hierarchy of a typical web page collection in a regular instance before any URL mapping or shadow site map is created. There are five levels depicted with the 44× level being the lowest representing the most product specific instance of information.

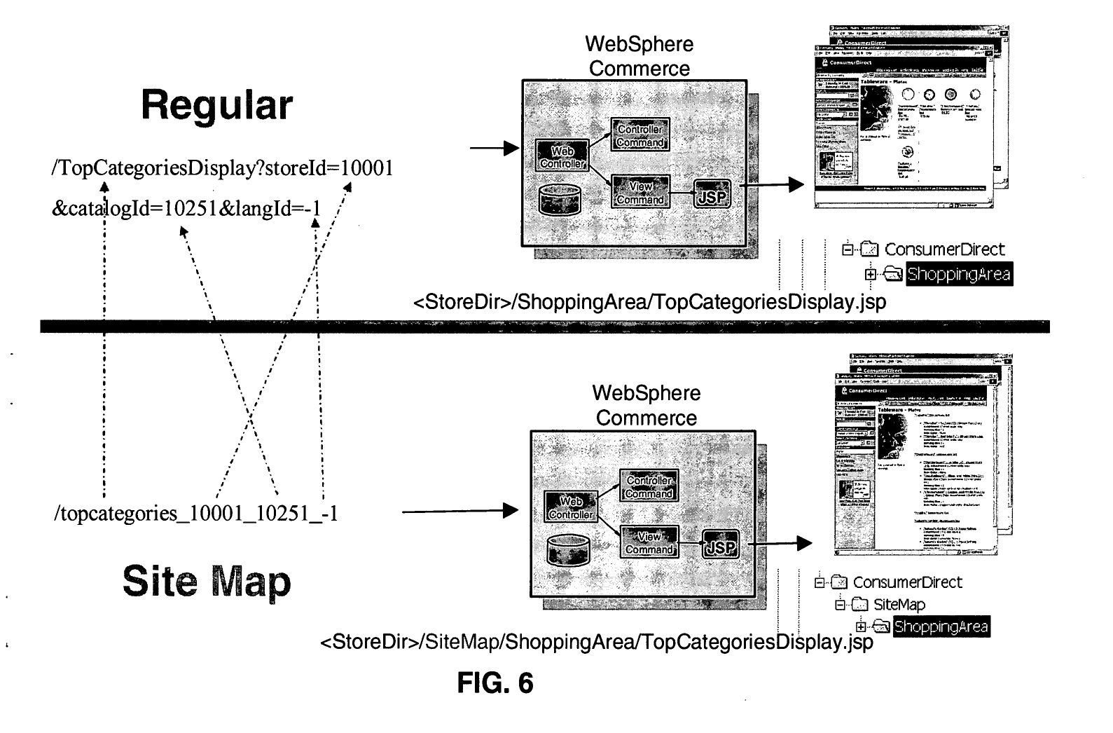

FIG. 4b is a block diagram illustrating the hierarchy of FIG. 4a when processing has been completed for the associated shadow site map pages. It may be seen that the top three levels of FIG. 4a have been removed as they were not necessary in the shadow site map pages. The JSPs for individual entries of the 43× and 44× levels of FIG. 4b would be provided in the “SiteMap” subdirectory as illustrated in the statement of <StoreDir>/SiteMap/ShoppingArea/TopCategoriesDisplay.jsp of FIG. 6. The “root” page of the site map pages is shown as numeral 500, providing linkage to other pages of the site map web site.

FIG. 5 is a text based example showing the relationship between an original format URL and the new or “static” URL format corresponding to the original format. The numerals should be regarded as pairs of entries to show the relationship between corresponding elements. Numeral 1 designates the separator character as seen in the new URL format and its entry in the mapping file. The original URL does not use the separator character. Numeral 2 relates the mapping between the entries of “category” and “CategoryDisplay”, as shown in the mapping file entry. Numeral 3 designates the mapping between the “storeId” name-value pair of the original URL to just the value portion of the new URL as defined in the mapping file. The second parameter of the mapping file defines the “catelogId” entry. Referring to numeral 4 may be seen the results of mapping the name-value pair for “catelogId” to just the value “10251” in the new URL format. Again in a similar manner, Numeral 5 and Numeral 6 define the mapping between the original URL elements “categoryId” and “langId” and those of the corresponding elements of the new URL, respectively.

Referring now to FIG. 6 is a pictorial representation of a URL in regular or dynamic form of the regular site (in the top half of the figure) compared to a new URL in static form in a shadow site map (in the bottom half of the figure). Arrows define the relationship between corresponding elements of the SiteMap URL static form and those of the dynamic or regular form. For example it is shown that “topcategories” of the SiteMap correspond to the “TopCategoriesDisplay” of the regular form. It may be seen in the typical display of a tree structure for the directory entries in the SiteMap instance show the location of the target JSP within “ShoppingArea” of the “SiteMap” subdirectory entry. The corresponding entry in the regular form instance is found within “ShoppingArea” of the ConsumerDirect directory (there is no intermediate level). Both JSPs exist simultaneously as the JSP contained under the “SiteMap” subdirectory has not replaced the similar JSP in the regular directory path.

Pages displayed in the regular instance present a higher level view, while a more detailed lower level view is displayed in the “SiteMap” view as indicated in the thumbnail pages of FIG. 6.

It should also be understood that the present invention can be realized in hardware, software, a propagated signal, or any combination thereof. Any kind of computer/server system(s) or other apparatus adapted for carrying out the methods described herein is suited. A typical combination of hardware and software could be a general purpose system with a computer program that, when loaded and executed, carries out the respective methods described herein. Alternatively a specific use computer containing specialized hardware for carrying out one or more of the functional tasks of the invention could be utilized. The present invention can also be embedded in a computer program product or a propagated signal which comprises all the respective features enabling the implementation of the methods described herein and which when loaded in a computer system is able to carry out these methods. Computer program, propagated signal, software program, program, or software in the present context mean any expression in any language code or notation of a set of instructions intended to cause a system having an information processing capability to perform a particular function either directly or after either or both of the following: (a) conversion to another language code or notation; and/or (b) reproduction in a different material form.

Of course, the above described embodiments are intended to be illustrative only and in no way limiting. The described embodiments of carrying out the invention are susceptible to many modifications of form, arrangement of parts, details and order of operation. The invention, rather, is intended to encompass all such modification within its scope, as defined by the claims.

What is claimed is:

1. A data processing system-implemented method for managing a web page having at least one URL link, the data processing system-implemented method comprising:
obtaining the web page containing the at least one URL link;
determining the at least one URL link to be of a dynamic format;
converting the dynamic format of the at least one URL link into a static format;
creating a shadow page, of the web page, containing the static format link; and
placing the shadow page in a repository.

2. The data processing system-implemented method of claim 1 further comprising:
receiving a request with the static format link from the shadow page;
mapping the static format link into a dynamic format to create a mapped request;
passing the mapped request to an application; and
retrieving a resource associated with the mapped request.

3. The data processing system-implemented method of claim 1, wherein the step of converting further comprises:
parsing the at least one URL link to determine a request key;
matching the request key with a corresponding key entry in a mapping file; and
replacing elements of the at least one URL link with matching elements of the corresponding key entry in accordance with the mapping file to create a static format link.

4. The data processing system-implemented method of claim 2, wherein the step of retrieving further comprises:
determining a specified repository from one of a configuration file and a mapping file;
accessing the specified repository;
matching the mapped request with a member of the specified repository to locate the resource; and
retrieving the resource as a response.

5. The data processing system-implemented method of claim 1, wherein the steps of converting and placing further comprises:
copying the obtained web page as a candidate page into a memory;
transforming the at least one URL link, contained within the copied candidate page, from a dynamic format into a static format;
creating an intermediate page from the candidate page; and
optimizing the intermediate page to create a shadow page in the repository.

6. The data processing system-implemented method of claim 1, wherein the repository is a dynamic shadow site map repository comprising at least one optimized shadow map page.

7. The data processing system-implemented method of claim 1, wherein the obtained web page is a JSP.

8. A data processing system for managing a web page having at least one URL link, the data processing system comprising:
an obtainer module for obtaining the web page containing the at least one URL link;
a determination module for determining the at least one URL link to be of a dynamic format;
a converter for converting the dynamic format of the at least one URL link into a static format;
a generator for creating a shadow page, of the web page, containing the static format link; and
an update module for placing the shadow page in a repository.

9. The data processing system of claim 8, further comprising:
a receiving module for receiving a request with the static format link from the shadow page;
a mapping module for mapping the static format link into a dynamic format to create a mapped request;
a transfer module for passing the mapped request to an application; and
a retrieving module for retrieving a resource associated with the mapped request.

10. The data processing system of claim 8, wherein said converter further comprises:
a parsing module for parsing the at least one URL link to determine a request key;
a comparator module for matching the request key with a corresponding key entry in a mapping file; and
an update module for replacing elements of the at least one URL link with matching elements of the corresponding key entry in accordance with the mapping file to create a static format link.

11. The data processing system of claim 9, wherein said retrieving module further comprises:
a determining module for determining a specified repository from one of a configuration file and a mapping file;
an access module for accessing the specified repository;
a comparator module for matching the mapped request with a member of the specified repository to locate the resource; and
a retrieve module for retrieving the resource as a response.

12. The data processing system of claim 8, wherein said converter and said update module further comprise:
a copy module for copying the obtained web page as a candidate page into a memory;
a transformer for transforming the at least one URL link, contained within the copied candidate page, from a dynamic format into a static format;
a generator for creating an intermediate page from the candidate page; and
an optimizer for optimizing the intermediate page to create a shadow page in the repository.

13. The data processing system of claim 8, wherein the repository is a dynamic shadow site map repository comprising at least one optimized shadow map page.

14. The data processing system of claim 8, wherein the obtained web page is a JSP.

15. A computer program product for directing a data processing system for managing a web page having at least one URL link, said computer program product embodied on a program usable medium embodying instructions executable by the data processing system, the instructions comprising:
data processing executable instructions for obtaining the web page containing the at least one URL link;
data processing executable instructions for determining the at least one URL link to be of a dynamic format;
data processing executable instructions for converting the dynamic format of the at least one URL link into a static format;
data processing executable instructions for creating a shadow page, of the web page, containing the static format link; and
data processing executable instructions for placing the shadow page in a repository.

16. The computer program product of claim 15, said instructions further comprising:
data processing executable instructions for receiving a request with the static format link from the shadow page;
data processing executable instructions for mapping the static format link into a dynamic format to create a mapped request;
data processing executable instructions for passing the mapped request to an application; and
data processing executable instructions for retrieving a resource associated with the mapped request.

17. The computer program product of claim 15, wherein the data processing executable instructions for converting further comprises:
data processing executable instructions for parsing the at least one URL link to determine a request key;
data processing executable instructions for matching the request key with a corresponding key entry in a mapping file;
data processing executable instructions for replacing elements of the at least one URL link with matching elements of the corresponding key entry in accordance with the mapping file to create a static format link.

18. The computer program product of claim 16, wherein the data processing executable instructions for retrieving further comprises:
data processing executable instructions for determining a specified repository from one of a configuration file and a mapping file;
data processing executable instructions for accessing the specified repository;
data processing executable instructions for matching the mapped request with a member of the specified repository to locate the resource; and
data processing executable instructions for retrieving the resource as a response.

19. The computer program product of claim 15, wherein the data processing executable instructions for converting and the data processing executable instructions for placing further comprises:
data processing executable instructions for copying the obtained web page as a candidate page into a memory;
data processing executable instructions for transforming the at least one URL link, contained within the copied candidate page, from a dynamic format into a static format;
data processing executable instructions for creating an intermediate page from the candidate page; and
data processing executable instructions for optimizing the intermediate page to create a shadow page in the repository.

20. The computer program product of claim 15, wherein the repository is a dynamic shadow site map repository comprising at least one optimized shadow map page.

21. The computer program product of claim 15, wherein the obtained web page is a JSP.
